(19) United States
(12) Patent Application Publication
(10) Pub. No.: US 2024/0324506 A1
(43) Pub. Date: Oct. 3, 2024

(54) SYSTEM AND METHOD FOR AN AGRICULTURAL HARVESTER

(71) Applicants: CNH Industrial Belgium N.V., Zedelgem (BE); CNH Industrial Brasil Ltda., Bairro Vale do Sereno, Nova Lima (BR)

(72) Inventors: Bart M.A. Missotten, Herent (BE); Andre Satoshi Seki, Sorocaba (BR); Yuanyuan Li, Leuven (BE); Sidney Roberto Dias de Carvalho, Florianópolis (BR); Patryk Alexandre Gonçalves, Florianópolis (BR); Henrique Roos Baltezan, Florianópolis (BR); Daniel Juchem Regner, Florianópolis (BR)

(21) Appl. No.: 18/617,832

(22) Filed: Mar. 27, 2024

Related U.S. Application Data
(60) Provisional application No. 63/454,811, filed on Mar. 27, 2023.

(51) Int. Cl. A01D 41/127; A01D 45/10; A01D 61/00

(52) U.S. Cl. CPC A01D 41/1276; A01D 45/10; A01D 61/008

(57) ABSTRACT

A system for an agricultural harvester can include a support structure configured to be operably coupled with an elevator housing. A carrier can be operably coupled with the support structure. A vision-based sensor can be operably coupled with the carrier. One or more light sources can be operably coupled with the carrier. A panel can be positioned along a portion of the carrier. A cleaning system can be configured to remove debris from the panel positioned between at least one of the vision-based sensor and the one or more light sources. A computing system performs various operations. The operations can include determining a detected percentage of pixels within the data indicating debris on the panel on the panel and initiating a cleaning routine to remove at least a portion of the debris from the panel.

### FIELD OF THE INVENTION

The present disclosure relates generally to agricultural harvesters, such as sugarcane harvesters, and, more particularly, to systems and methods for monitoring operational conditions of the agricultural harvester.

### BACKGROUND OF THE INVENTION

Agricultural harvesters can include an assembly of processing components for processing harvested material. For instance, within a sugarcane harvester, severed sugarcane stalks are conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device. In some cases, a secondary extractor may remove additional airborne debris (e.g., dust, dirt, leaves, etc.) before the remaining harvested material is delivered to the external storage device.

During the operation of the harvester, an amount of processed harvested material may be difficult to monitor. Accordingly, systems and methods for monitoring the amount of processed harvested material during the harvest operation would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for an agricultural harvester that includes a support structure configured to be operably coupled with an elevator housing. A carrier is operably coupled with the support structure. A vision-based sensor is operably coupled with the carrier. One or more light sources is operably coupled with the carrier. A panel is positioned along a portion of the carrier. A cleaning system is configured to remove debris from the panel positioned between at least one of the vision-based sensor and the one or more light sources.

In some aspects, the present subject matter is directed to a computer-implemented method for agricultural harvesting. The method includes receiving, from a sensor system, data indicative of an percentage of pixels within the data indicating debris on the panel on a panel of a sensor. The method also includes determining, with a computing system, a detected percentage of pixels within the data indicating debris on the panel on the panel. The method further includes comparing, with the computing system, the detected percentage of pixels within the data indicating debris on the panel to a threshold amount. Lastly, the method includes initiating, with a cleaning system, a cleaning routine when the detected percentage of pixels within the data indicating debris on the panel is greater than or equal to a threshold amount.

In some aspects, the present subject matter is directed to a system for an agricultural harvester that includes a support structure configured to be operably coupled with an elevator housing. A carrier is operably coupled with the support structure. A vision-based sensor is operably coupled with the carrier. One or more light sources is operably coupled with the carrier. A panel is positioned along a portion of the carrier. A cleaning system is configured to remove debris from the panel positioned between at least one of the vision-based sensor and the one or more light sources. A computing system includes one or more processors and one or more non-transitory computer-readable media that collectively store instructions that, when executed by the one or more processors, configure the computing system to perform operations. The operations include determining a detected percentage of pixels within the data indicating debris on the panel on the panel and initiating a cleaning routine to remove at least a portion of the debris from the panel.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural harvester in accordance with aspects of the present subject matter;

FIG. 2 illustrates a perspective view of a rear portion of the agricultural harvester in accordance with aspects of the present subject matter;

FIG. 3 illustrates a cross-sectional view taken along the line III-III of FIG. 2;

FIG. 4 illustrates a top perspective view of a sensor assembly in accordance with aspects of the present subject matter;

FIG. 5 illustrates a top perspective view of the sensor assembly in accordance with aspects of the present subject matter;

FIG. 6 illustrates a side plan view of the sensor assembly in accordance with aspects of the present subject matter;

FIG. 7 illustrates a side plan view of the sensor assembly in accordance with aspects of the present subject matter;

FIG. 8 illustrates a perspective view of the sensor assembly in accordance with aspects of the present subject matter;

FIG. 9 illustrates a bottom plan view of the sensor assembly in accordance with aspects of the present subject matter;

FIG. 10 illustrates a perspective view of a rear portion of the agricultural harvester in accordance with aspects of the present subject matter;

FIG. 11 illustrates a schematic view of a system for the harvester in accordance with aspects of the present subject matter;

FIG. 12 illustrates a flow diagram of a method for agricultural harvesting in accordance with aspects of the present subject matter; and

FIG. 13 illustrates a flow diagram of a method for agricultural harvesting in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a path. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used herein, “harvested material” can include crop product, which may be in the form of stalks (or to be collected crop or after collected crop), billets (modified stalks or modified collected crop), and/or debris, which may be any object other than the stalks or the billets (or the collected crop) (e.g., dust, dirt, leaves, etc.).

In general, the present subject matter is directed to a system for an agricultural harvester. The system can include a support structure configured to be operably coupled with an elevator housing. A carrier can be operably coupled with the support structure. A vision-based sensor (or another sensor) can be operably coupled with the carrier. One or more light sources can be operably coupled with the carrier. A panel can be positioned along a portion of the carrier.

A cleaning system can be configured to remove debris from the panel positioned between at least one of the vision-based sensor and the one or more light sources. In some instances, a computing system can include one or more processors and one or more non-transitory computer-readable media that collectively store instructions that, when executed by the one or more processors, configure the computing system to perform operations. The operations can include determining a detected percentage of pixels within the data indicating debris on the panel on the panel and initiating a cleaning routine to remove at least a portion of the debris from the panel. In various examples, determining a detected percentage of pixels within the data indicating debris on the panel on the panel may include utilizing any suitable image processing algorithm(s) to determine the percentage of pixels within the data indicating debris on the panel on a component (e.g., the panel) within the data provided by the sensor system. Further, the cleaning routine may include providing information to a user interface in the form of a suggestion to clean the panel. Additionally or alternatively, the cleaning routine can include activating a pump to direct fluid from a reservoir through a nozzle and towards the panel of the vision-based sensor. Additionally or alternatively, the cleaning routine can include activating an air pump to direct air through an air nozzle and toward the panel.

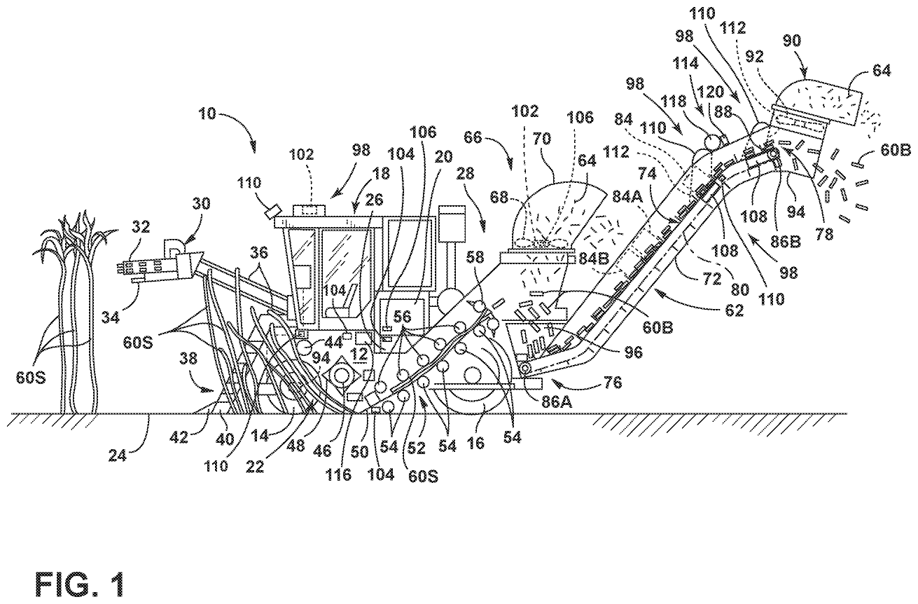

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable agricultural harvester.

As shown in FIG. 1, the harvester 10 can include a frame 12, a pair of front wheels 14, a pair of rear wheels 16, and an operator's cab 18. The harvester 10 may also include a power source 20 (e.g., an engine mounted on the frame 12) that powers one or both pairs of the wheels 14, 16 via a driveline assembly 22 (e.g., a transmission) to traverse a field 24. Alternatively, the harvester 10 may be a track-driven harvester and, thus, may include tracks driven by the power source 20 as opposed to the illustrated wheels 14, 16. The power source 20 may also drive a hydraulic fluid pump 26 configured to generate pressurized hydraulic fluid for a hydraulic circuit, which may be configured to power various components of the harvester 10, including the driveline assembly 22.

The harvester 10 may also include a material processing system 28 incorporating various components, assemblies, and/or sub-assemblies of the harvester 10 for cutting, processing, cleaning, and discharging sugarcane as the cane is harvested from an agricultural field 24. For instance, the material processing system 28 may include a topper assembly 30 positioned at the front end portion of the harvester 10 to intercept sugarcane as the harvester 10 is moved in a forward direction. As shown, the topper assembly 30 may include both a gathering disk 32 and a cutting disk 34. The gathering disk 32 may be configured to gather the sugarcane stalks 60S so that the cutting disk 34 may be used to cut off the top of each stalk 60S. As is generally understood, the height of the topper assembly 30 may be adjustable via a pair of arms 36, which may be hydraulically raised and lowered.

The material processing system 28 may further include a crop divider 38 that extends upwardly and rearwardly from the field 24. In general, the crop divider 38 may include two spiral feed rollers 40. Each feed roller 40 may include a ground shoe 42 at its lower end portion to assist the crop divider 38 in gathering the sugarcane stalks 60S for harvesting. Moreover, as shown in FIG. 1, the material processing system 28 may include a knock-down roller 44 positioned near the front wheels 14 and a fin roller 46 positioned behind the knock-down roller 44. As the knock-down roller 44 is rotated, the sugarcane stalks 60S being harvested are knocked down while the crop divider 38 gathers the stalks 60S from agricultural field 24. Further, as shown in FIG. 1, the fin roller 46 may include a plurality of intermittently mounted fins 48 that assist in forcing the sugarcane stalks 60S downwardly. As the fin roller 46 is rotated during the harvest, the sugarcane stalks 60S that have been knocked down by the knock-down roller 44 are separated and further knocked down by the fin roller 46 as the harvester 10 continues to be moved in the forward direction relative to the field 24.

Referring still to FIG. 1, the material processing system 28 of the harvester 10 may also include a base cutter assembly 50 positioned behind the fin roller 46. The base cutter assembly 50 may include blades for severing the sugarcane stalks 60S as the cane is being harvested. The blades, which may be located on a periphery section of the base cutter assembly 50, can be rotated by the hydraulic circuit. Additionally, in several embodiments, the blades may be angled downwardly to sever the base of the sugarcane as the cane is knocked down by the fin roller 46.

Moreover, the material processing system 28 may include a feed roller assembly 52 located downstream of the base cutter assembly 50 for moving the severed stalks 60S of sugarcane from base cutter assembly 50 along the processing path of the material processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris (e.g., rocks, dirt, and/or the like) may be allowed to fall through bottom rollers 54 onto the field 24.

In addition, the material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks 60S into pieces or “billets” 60B, which may be, for example, six (6) inches long. The billets 60B may then be propelled towards an elevator assembly 62 of the material processing system 28 for delivery to an external receiver or storage device.

The debris 64 (e.g., dust, dirt, leaves, etc.) separated from the sugarcane billets 60B may be expelled from the harvester 10 through a primary extractor 66 of the material processing system 28, which may be located downstream of the chopper assembly 58 and may be oriented to direct the debris 64 outwardly from the harvester 10. Additionally, an extractor fan 68 may be mounted within an extractor housing 70 of the primary extractor 66 for generating a suction force or vacuum sufficient to force the debris 64 through the primary extractor 66. The separated or cleaned billets 60B, which may be heavier than the debris 64 expelled through the extractor 66, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60B on the elevator 74 as the sugarcane billets 60B are elevated along a top surface of the elevator 74 defined between its proximal and distal end portions 76, 78. A region 84 for retaining the harvested material may be defined between the first and second paddles 82 operably coupled with the elevator 74. As such, a first region 84A may be defined between first and second paddles 82, a second region 84B may be defined between the second and a third paddle 82, and so on. Additionally, the elevator 74 may include lower and upper sprockets 86A, 86B positioned at its proximal and distal end portions 76, 78, respectively. As shown in FIG. 1, an elevator motor 88 may be coupled to one of the sprockets (e.g., the upper sprocket 86B) for driving the chain 80, thereby allowing the chain 80 and the paddles 82 to travel in a loop between the proximal and distal ends 76, 78 of the elevator 74.

Moreover, in some embodiments, debris 64 (e.g., dust, dirt, leaves, etc.) separated from the elevated sugarcane billets 60B may be expelled from the harvester 10 through a secondary extractor 90 of the material processing system 28 coupled to the rear end portion of the elevator housing 72. For example, the debris 64 expelled by the secondary extractor 90 may be debris 64 remaining after the billets 60B are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the harvester 10. Additionally, an extractor fan 92 may be mounted at the base of the secondary extractor 90 for generating a suction force or vacuum sufficient to force the debris 64 through the secondary extractor 90. The separated, cleaned billets 60B, heavier than the debris 64 expelled through the primary extractor 66, may then fall from the distal end portion 78 of the elevator 74. In some instances, the billets 60B may fall through an elevator discharge opening 94 defined by the elevator assembly 62 into an external storage device, such as a sugarcane billet cart.

During operation, the harvester 10 traverses the agricultural field 24 for harvesting sugarcane. After the height of the topper assembly 30 is adjusted via the arms 36, the gathering disk 32 on the topper assembly 30 may function to gather the sugarcane stalks 60S as the harvester 10 proceeds across the field 24, while the cutting disk 34 severs the leafy tops of the sugarcane stalks 60S for disposal along either side of harvester 10. As the stalks 60S enter the crop divider 38, the ground shoes 42 may set the operating width to determine the quantity of sugarcane entering the throat of the harvester 10. The spiral feed rollers 40 then gather the stalks 60S into the throat to allow the knock-down roller 44 to bend the stalks 60S downwardly in conjunction with the action of the fin roller 46. Once the stalks 60S are angled downward as shown in FIG. 1, the base cutter assembly 50 may then sever the base of the stalks 60S from field 24. The severed stalks 60S are then, by the movement of the harvester 10, directed to the feed roller assembly 52.

The severed sugarcane stalks 60S are conveyed rearwardly by the bottom and top rollers 54, 56, which compresses the stalks 60S, makes them more uniform, and shakes loose debris 64 to pass through the bottom rollers 54 to the field 24. At the downstream end portion of the feed roller assembly 52, the chopper assembly 58 cuts or chops the compressed sugarcane stalks 60S into pieces or billets 60B (e.g., 6-inch cane sections). The processed harvested material discharged from the chopper assembly 58 is then directed as a stream of billets 60B and debris 64 into the primary extractor 66. The airborne debris 64 (e.g., dust, dirt, leaves, etc.) separated from the billets 60B is then extracted through the primary extractor 66 using suction created by the extractor fan 68. The separated/cleaned billets 60B then be directed to an elevator hopper 96 into the elevator assembly 62 and travel upwardly via the elevator 74 from its proximal end portion 76 to its distal end portion 78. During normal operation, once the billets 60B reach the distal end portion 78 of the elevator 74, the billets 60B fall through the elevator discharge opening 94 to an external storage device. If provided, the secondary extractor 90 (with the aid of the extractor fan 92) blows out trash/debris 64 from the harvester 10, similar to the primary extractor 66.

In various examples, the harvester 10 may also include a sensor system 98 including various onboard sensor(s) for monitoring one or more operating parameters or conditions of the harvester 10. For instance, the sensor system 98 may include or be associated with various different speed sensor assemblies 102 for monitoring the speed of the harvester 10, and/or the operating speed of one or more components of the harvester 10. In several embodiments, the speed sensor assemblies 102 may be used to detect or monitor various different speed-related parameters associated with the harvester 10, including, but not limited to, the ground speed of the harvester 10, the engine speed of the harvester's engine (e.g., engine RPM), the elevator speed of the elevator assembly 62, the rotational speed of the blades of the base cutter assembly 50, the rotational speed of the chopper assembly 58, the rotational speed of the rollers 54, 56 of the feed roller assembly 52, the fan speed associated with the primary extractor 66 and/or the secondary extractor 90, and/or any other suitable operating speeds associated with the harvester 10. For example, as shown in FIG. 1, a first speed sensor assembly 102 is provided in operative association with the primary extractor 66 (e.g., a rotational speed sensor provided in association with the elevator motor 88) to allow the fan speed to be monitored, while a second speed sensor assembly 102 (e.g., a wheel speed sensor or a GPS-enabled device) may be provided in operative association with another component of the harvester 10 (e.g., the wheels 14, 16 and/or cab 18) to allow the ground speed of the harvester 10 to be continuously monitored.

Additionally, in several embodiments, the sensor system 98 may include or incorporate one or more position sensor assemblies 104 to monitor one or more corresponding position-related parameters associated with the harvester 10. Position-related parameters that may be monitored via the position sensor(s) 104 include, but are not limited to, the cutting height of the base cutter assembly 50, the relative positioning of the bottom and top rollers 54, 56 of the feed roller assembly 52, the vertical travel or position of the chassis or frame 12 of the harvester 10, and/or any other suitable position-related parameters associated with the harvester 10. For instance, as shown in FIG. 1, a position sensor assembly 104 may be mounted to the harvester's frame 12 to monitor the vertical position or travel of the chassis relative to a given reference point.

Moreover, in several embodiments, the sensor system 98 may include or incorporate one or more pressure sensor assemblies 106 to monitor one or more corresponding pressure-related conditions or parameters associated with the harvester 10. For instance, pressure-related conditions or parameters that may be monitored via the pressure sensor(s) 106 include, but are not limited to, the fluid pressures associated with the hydraulic fluid supplied to one or more hydraulic components of the harvester 10, such as hydraulic motor(s) rotationally driving the base cutter assembly 52 (e.g., the base cutter pressure), hydraulic motor(s) rotationally driving the feed roller assembly 50, hydraulic motor(s) rotationally driving the chopper assembly 58, hydraulic motor(s) rotationally driving the fan 68 of the primary extractor 66, hydraulic motor(s) rotationally driving the elevator assembly 62, hydraulic motor(s) rotationally driving the secondary extractor 90, and/or any other suitable pressure-related conditions or parameters associated with the harvester 10. For instance, as shown in FIG. 1, a pressure sensor assembly 106 may be provided in operative association with the base cutter assembly 50 to monitor the base cutter pressure.

In some embodiments, the sensor system 98 may include or incorporate one or more load sensor assemblies 108 (e.g., one or more load cells or sensorized load plates) to monitor one or more corresponding load-related conditions or parameters associated with the harvester 10. For instance, as shown in FIG. 1, one or more load sensor assemblies 108 may be provided in operative association with the elevator assembly 62 to allow the weight or mass flow rate of the harvested material being directed through the elevator 74 to be monitored.

Additionally, in some embodiments, the sensor system 98 may include or incorporate one or more vision-based or wave-based sensor assemblies 110 used to capture sensor data indicative of one or more observable conditions or parameters associated with the harvester 10, such as by providing a camera or LIDAR device to allow the potential upcoming stalk mass within the field 24 to be estimated based on the received vision-based data (e.g., image(s)) or by providing an internally installed camera or radar device to allow sensor data to be captured that is associated with a detected foliage ratio of the harvested material at the elevator 74 and/or within any of location of the harvester 10 and/or a mass of the harvested material through the material processing system 28. For instance, as shown in FIG. 1, a forward looking vision-based sensor assembly 110 may be installed on the cab 18 with a field of view directed in front of the harvester 10 to allow images or other vision-based data to be captured that provides an indication of the upcoming stalk mass within the field 24. Additionally or alternatively, as shown in FIG. 1, a vision-based sensor assembly 110 may be installed proximate to the knock-down roller 44 with a field of view directed towards an infeed location of the harvested material entering the harvester 10 to allow images or other vision-based data to be captured that provides an indication of the upcoming stalk mass within the field 24. Additionally or alternatively, as shown in FIG. 1, one or more vision-based sensor assemblies 110 may be installed proximate to the elevator housing 72 with a field of view directed towards the elevator 74 to allow images or other vision-based data to be captured that provide an indication of the debris 64 and/or billets 60B, (i.e., detected foliage ratio) downstream of the primary extractor 66.

As illustrated in FIG. 1, the vision-based sensor assembly 110 may include a field of view 112 that is directed towards a top portion of the elevator 74. Moreover, the field of view 112 may overlap with a common region 84 with the load sensor assembly 108. In such instances, the vision-based sensor assembly 110 and the load sensor assembly 108 may be configured to determine a conditions or parameters associated with the harvester 10 with reference to a common region 84.

In various examples, a cleaning system 114 may be installed on the harvester 10. The cleaning system 114 may be operatively coupled with the sensor system 98. In such instances, the cleaning system 114 may be configured to remove debris and/or any other material from a component of the sensor system 98. Additionally or alternatively, the cleaning system 114 may be operatively coupled with any other component of the harvester 10. In some cases, the cleaning system 114 may provide a liquid and/or pressurized air to the to be cleaned surface, component, or assembly.

In some examples, the harvester 10 can include a heating ventilation, and air conditioning (HVAC) system 116 that is operatively coupled with the cab 18 and/or any other component of the harvester 10. During the operation of the HVAC system 116, a heat exchange fluid circulates in a closed system that can include a compressor, a first heat exchanger (e.g., a condenser), a flow restriction, and a second heat exchanger called an evaporator. As ambient air passes over the evaporator and is cooled it is no longer able to hold the quantity of moisture present as water vapor. In turn, droplets of liquid water condense. This fluid may be collected and stored within a reservoir 118 for use by the cleaning system 114. In such instances, a pump 120 may be operably coupled with the HVAC system 116 and the reservoir 118 to move the fluid therebetween. Moreover, the pump 120 may be further configured to move the fluid from the reservoir 118 to one or more nozzles 122 within the cleaning system 114.

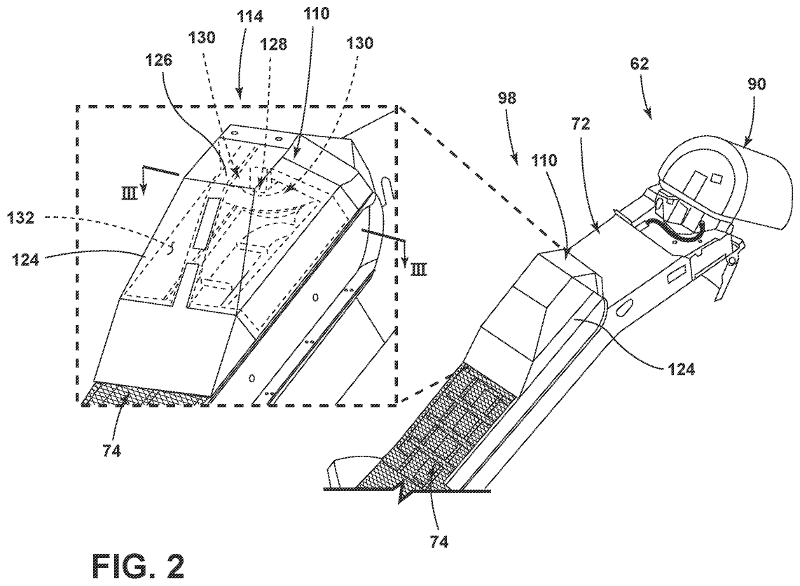

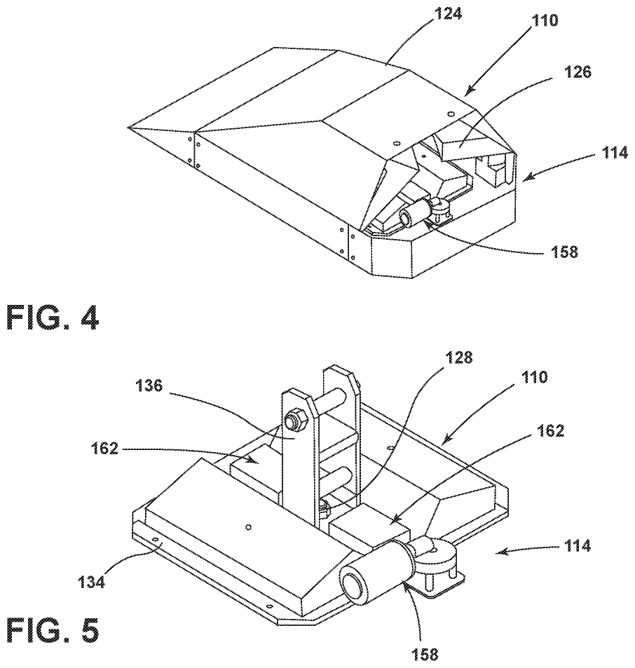

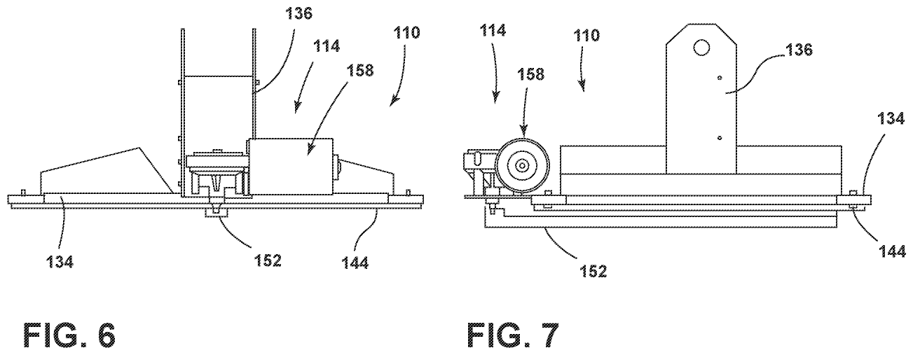

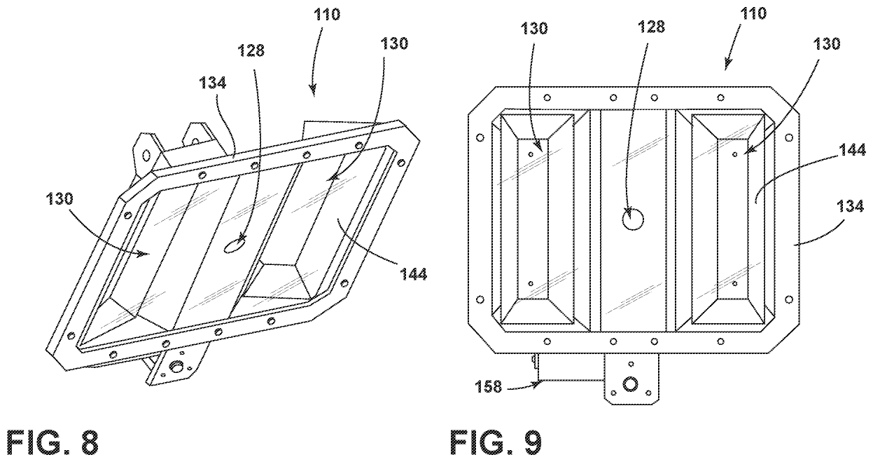

Referring now to FIGS. 2-10, the sensor system 98 may include a vision-based sensor assembly 110 that may be operably coupled with the elevator housing 72. The vision-based sensor assembly 110 may include a sensor housing 124, a support structure 126, one or more vision-based sensors 128 installed within the sensor housing 124, and one or more light sources 130 configured to illuminate an area within the field of view 112 of the one or more vision-based sensors 128.

As illustrated, the support structure 126 may be operably coupled with the elevator housing 72. In addition, the cover may be positioned over at least a portion of the support structure 126 that is opposite the elevator 74. As such, a cavity 132 may be defined between the sensor housing 124 and the elevator 74.

A sensor carrier 134 may be operably coupled with the support structure 126 through a brace 136 and/or through any other manner. The carrier 134 may define a vision-based sensor segment 138 and/or one or more light source segments 140. The light source segments 140 may respectively define a channel 142.

The one or more vision-based sensors 128 may be operably coupled with a computing system 202 and positioned at least partially within the cavity 132 producing a field of view 112 directed towards the elevator 74 to allow images or other vision-based data to be captured that provides an indication of the debris 64 (FIG. 1) and/or billets 60B within the field of view 112. In various examples, each of the one or more vision-based sensor assemblies 110 may include an area-type image sensor, such as a CCD or a CMOS image sensor, and image-capturing optics that capture an image of a field of view. In various embodiments, the vision-based sensor 128 may correspond to a stereographic camera having two or more lenses with a separate image sensor for each lens to allow the camera to capture stereographic or three-dimensional images. It will be appreciated that the vision-based sensor assembly 110 may additionally or alternatively include radar sensors, ultrasound sensors, LIDAR devices, etc. without departing from the teachings provided herein.

The one or more light sources 130 may be operably coupled with the computing system 202 and positioned within the channels 142 of the sensor carrier 134. The one or more light sources 130 can be configured to illuminate an area within the field of view 112 of the one or more vision-based sensors 128. The one or more light sources 130 may be any lighting apparatuses suitable for illuminating a portion of the elevator 74, such as light-emitting diodes (LED), tungsten-based light sources, halogen-based light sources, high-intensity discharge (HID) sources, such as xenon, laser-based light sources, vertical-cavity surface-emitting laser-based light sources (VCSEL), etc. In some instances, the one or more light sources 130 can be near-infrared (NIR) lamps positioned near the sensor assemblies 110 to illuminate the environment in low-light conditions for the sensor assemblies 110.

A panel 144 may be positioned along the carrier 134 between the one or more light sources 130 and/or the vision-based sensor 128 and the elevator 74. The panel 144 may be configured from any practicable material and include one or more transparent or translucent portions that define a light source focal region 146 of the panel 144 and/or a vision-based sensor focal region 148 of the panel 144. In some cases, the panel 144 may be configured such that no material can accumulate between the vision-based sensor 128 and the one or more light sources 130. To this end, a sealing may be positioned at least partially between the vision-based sensor 128 and the panel 144. Similarly, the sealing may be positioned at least partially between the one or more light sources 130 (e.g., a front end portion thereof) and the panel 144.

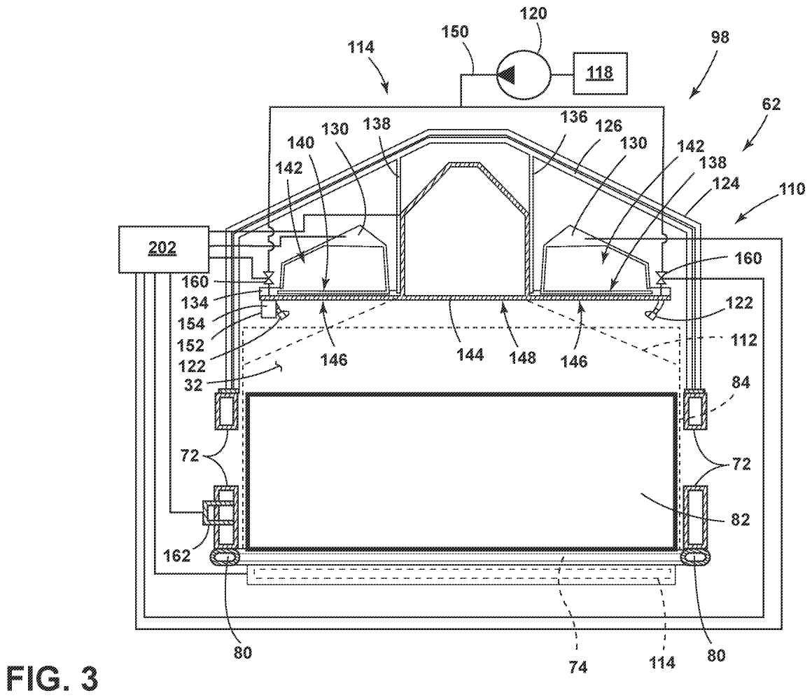

With further reference to FIGS. 2-10, the cleaning system 114 may be configured to provide a liquid and/or pressurized air on the panel 144. In the example illustrated in FIG. 3, the cleaning system 114 includes a pair of liquid nozzles 122, a liquid reservoir 118, and a liquid pump 120. However, it will be appreciated that the cleaning system 114 may include an air nozzle, a compressed air tank, and/or an air pump in addition to or instead of the liquid-based system. As provided herein, the liquid in the reservoir 118 may be received from another location within the harvester 10, such as from the HVAC system 116 (FIG. 1), and/or from a remote source. The liquid in the reservoir 118 is pumped by the pump 120 through a pipe 150 and the nozzles 122. The pumped liquid is exhausted from the nozzles 122 toward the panel 144. It will be appreciated that the nozzles 122 may be placed in any practicable location. For example, the nozzle 122 may be operably coupled with a wiper assembly 152 and movable with the wiper assembly 152 and/or otherwise positioned to practicably clean the panel 144. The wiper assembly 152 can include an arm 154, a wiper 156 operably coupled with the arm 154, and an actuator 158 configured to alter a position of the arm 154 and the wiper 156. The actuator 158 may be operably coupled with the carrier 134 and the computing system. The wiper 156 may be any practicable product that contacts the panel 144 to remove liquid, debris 64 (FIG. 1), and/or any other material from a surface of the panel 144.

In operation, when a cleaning routine is initiated, a computing system 202 may activate the pump 120 thereby directing fluid from the reservoir 118 through the pipe 150. In addition, the computing system may actuate a valve 160 positioned between the pump 120 and each nozzle 122 to direct liquid at the panel 144. The computing system 202 may be capable of various cleaning routines that include spraying air and liquid contemporaneously and/or successively at the panel 144, just liquid at the panel 144, and/or just air at the panel 144.

As illustrated in FIGS. 2-10, a heat sink 162 may also be operatively coupled with the carrier 134. In various examples, the heat sink 162 may be configured to remove heat generated by the light sources 130, the vision-based sensor 128, the computing system, and/or any other component.

Referring still to FIGS. 2-10, the sensor system 98 may include or incorporate one or more load sensor assemblies 108 (e.g., one or more load cells or sensorized load plates) to monitor one or more corresponding load-related conditions or parameters associated with the harvester 10. For instance, as shown in FIG. 3, the load sensor assembly 108 may be provided in operative association with the elevator assembly 62 to allow the weight or mass flow rate of the harvested material being directed along the elevator 74 to be monitored. In some cases, the cleaning system 114 may additionally or alternatively be configured to remove liquid, debris 64 (FIG. 1), and/or any other material from the load sensor assembly 108.

With further reference to FIGS. 2-10, the sensor system 98 may include one or more movement sensor assemblies 164, such as a proximity sensor, which may be configured to detect when a component of the harvester 10, such as a paddle 82 on the elevator 74, changes position relative to the sensor assembly 164. As such, while the elevator 74 is in motion, the movement sensor assembly 164 may detect a time between paddles 82 passing thereby and/or quantify the speed of the elevator 74 and various regions 84 associated with the elevator 74 in any other manner.

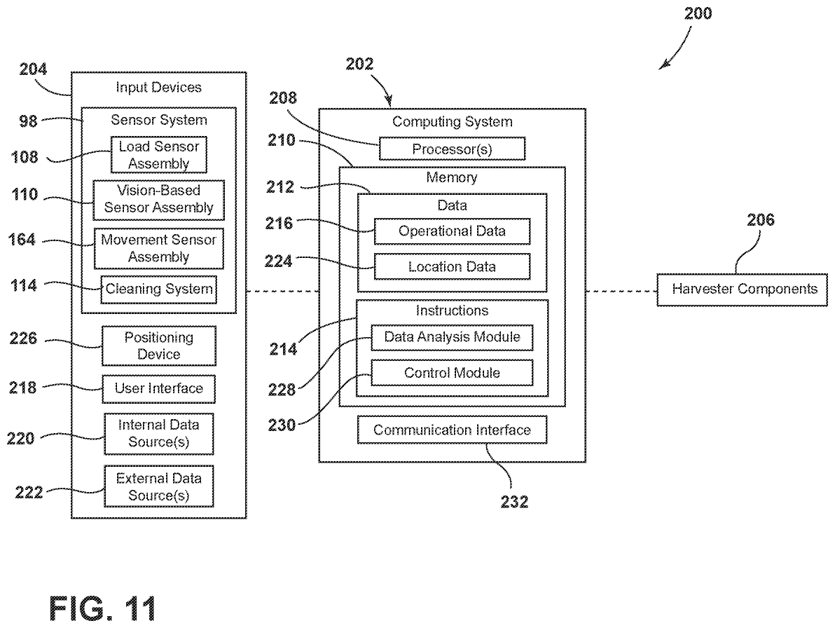

Referring now to FIG. 11, a schematic view of embodiments of a system 200 is illustrated in accordance with aspects of the present subject matter. In general, the system 200 will be described herein with reference to the harvester 10 described above with reference to FIGS. 1-10. However, it will be appreciated that the disclosed system 200 may generally be utilized with harvesters 10 having any suitable harvester configuration.

In several embodiments, the system 200 may include the computing system 202, various input devices 204 configured to be communicatively coupled to and/or controlled by the computing system 202, and/or various components 206 of the harvester 10 configured to be communicatively coupled to and/or controlled by the computing system 202. In some embodiments, the computing system 202 is physically coupled to the harvester 10. In other embodiments, the computing system 202 is not physically coupled to the harvester 10 and instead may communicate with the harvester 10 over a network.

In general, the computing system 202 may correspond to any suitable processor-based device(s), such as a computing device or any combination of computing devices. Thus, as shown in FIG. 11, the computing system 202 may generally include one or more processor(s) 208 and associated memory devices 210 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 210 may generally comprise memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 210 may generally be configured to store information accessible to the processor(s) 208, including data 212 that can be retrieved, manipulated, created, and/or stored by the processor(s) 208 and instructions 214 that can be executed by the processor(s) 208.

In several embodiments, the data 212 may be stored in one or more databases. For example, the memory 210 may include an operational database 216 for storing input data received from the input device(s) 204. For example, the input device(s) 204 may include the sensor system 98 configured to monitor one or more parameters and/or conditions associated with the harvester 10 and/or the operation being performed therewith (e.g., including one or more of the various sensor assemblies 102, 104, 106, 108, 110 described above), one or more user interfaces 218 for allowing operator inputs to be provided to the computing system 202 (e.g., buttons, knobs, dials, levers, joysticks, touch screens, and/or the like), one or more other internal data sources 220 associated with the harvester 10 (e.g., other devices, databases, etc.), one or more external data sources 222 (e.g., a remote computing device or sever, and/or any other suitable input device(s) 204. The data received from the input device(s) 204 may, for example, be stored within the operational database 216 for subsequent processing and/or analysis. Additionally, or alternatively, the memory 206 may implement machine learning methods and algorithms that utilize one or several machine learning techniques including, for example, decision tree learning, including, for example, random forest or conditional inference trees methods, neural networks, support vector machines, clustering, and Bayesian networks. In some instances, the machine learning engine may allow for changes to be performed without human intervention.

In several embodiments, the computing system 202 may be configured to receive data from the input device(s) 204 that is associated with one or more “operation-related” conditions. The operation-related condition data may, for example, be: based directly or indirectly on sensor data received from the sensor systems 98 and/or the location data received from the positioning device(s) 226; calculated or determined by the computing system 202 based on any data accessible to the system 200 (e.g., including data accessed, received, or transmitted from internal data sources 220 and/or external data sources 222); received from the operator (e.g., via the user interface 218); and/or the like. In various cases, operation-related conditions may include but are not limited to, levels of debris 64 (FIG. 1) (or other material) on various components of the harvester 10, harvest-related parameters and/or settings of the harvester 10 (e.g., sensed or calculated harvest-related parameters or operator-selected settings), vehicle commands for the harvester 10, vehicle configuration parameters, application-related parameters, field-related parameters, and/or the like. For instance, examples of operation-related conditions include but are not limited to, engine speed, ground speed, elevator speed, base cutter height, base cutter pressure, chopper speed, chopper pressure, floating roller position or displacement, the vertical position or travel of the chassis or frame 12, the fan speed associated with the primary and/or secondary extractor, hydraulic motor usage, foliage proportion, base cutter direction (forward or reverse), raising or lowering of the topper assembly, raising or lowering of the suspension, the model/type of the chopper assembly, the size of the elevator assembly 62, tire/track parameters, the location within which the harvester 10 is operating, farm-specific conditions, time-related conditions (day/night), humidity data, field NDVI data, yield prediction data, soil analysis data, and/or the like.

It will be appreciated that, in addition to being considered an input device(s) 204 that allows an operator to provide inputs to the computing system 202, the user interface 218 may also function as an output device. For instance, the user interface 218 may be configured to allow the computing system 202 to provide feedback to the operator (e.g., visual feedback via a display or other presentation device, audio feedback via a speaker or other audio output device, and/or the like).

Moreover, in several embodiments, the memory 210 may also include a location database 224 storing location information about the harvester 10 and/or information about the field 24 (FIG. 1) being processed (e.g., a field map). Such location database 224 may, for example, correspond to a separate database or may form part of the operational database 216. As shown in FIG. 11, the computing system 202 may be communicatively coupled to a positioning device(s) 226 installed on or within the harvester 10. For example, the positioning device(s) 226 may be configured to determine the exact location of the harvester 10 using a satellite navigation position system (e.g., a GPS, a Galileo positioning system, the Global Navigation satellite system (GLONASS), the BeiDou Satellite Navigation and Positioning system, and/or the like). In such an embodiment, the location determined by the positioning device(s) 226 may be transmitted to the computing system 202 (e.g., in the form of coordinates) and subsequently stored within the location database 224 for subsequent processing and/or analysis.

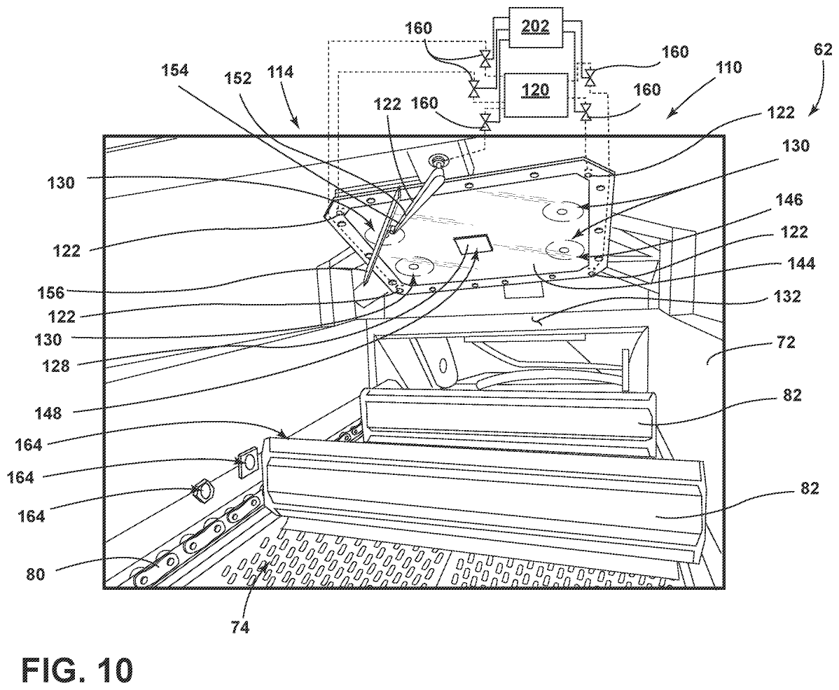

Referring still to FIG. 11, in several embodiments, the instructions 214 stored within the memory 210 of the computing system 202 may be executed by the processor(s) 208 to implement a data analysis module 228. In general, the data analysis module 228 may be configured to analyze the input data (e.g., a set of input data received at a given time or within a given time period or a subset of the data, which may be determined through a pre-processing method) to determine the operation-related condition. For example, the data analysis module 228 can utilize any suitable image processing algorithm(s) to determine the percentage of pixels within the data indicating debris 64 (FIG. 1) on a component (e.g., the panel 144 (FIG. 10)) within the data provided by the sensor system 98. In some embodiments, an algorithm that compares subsequent images from the vision-based sensor assembly 110 may be utilized to determine whether each pixel within the image is sufficiently similar to a previous image within various regions of the image thereby indicating debris 64 (FIG. 1) or another material may be adhered to the panel 144. Additionally or alternatively, a sharpness detection algorithm may be utilized to determine a percentage of pixels within the data indicating debris 64 (FIG. 1) on a component (e.g., the panel 144 (FIG. 10)).

Additionally or alternatively, a texture-based algorithm may be utilized that relies on the orientations of image gradients to differentiate a billet or other debris 64 (FIG. 1) that is transferred along the elevator 74 from a debris 64 (FIG. 1) or other materials that may be adhered to the panel 144, or other sensor system components. In other embodiments, a color-based algorithm may be utilized that relies on color differences to differentiate between a billet or other debris 64 (FIG. 1) that is transferred along the elevator 74 from a debris 64 (FIG. 1) or other materials that may be adhered to the panel 144, or other sensor system components. In further embodiments, the algorithm may identify the differences in the reflectivity or spectral absorption between a billet or other debris 64 (FIG. 1) that is transferred along the elevator 74 from a debris 64 (FIG. 1) or other materials that may be adhered to the panel 144, or other sensor system component. Additionally or alternatively, the algorithm may utilize a fast Fourier transform (FFT) to determine a percentage of pixels within the data indicating debris 64 (FIG. 1) on the panel 144 or other materials that may be adhered to the panel 144, or other sensor system components. It will be appreciated, however, that any suitable image processing algorithm(s) may be utilized to determine the operation-related condition.

Referring still to FIG. 11, the instructions 214 stored within the memory 210 of the computing system 202 may also be executed by the processor(s) 208 to implement a control module 230. In various examples, the control module 230 may be configured to adjust the operation of the harvester 10 by controlling one or more components of the material processing system 28 and/or initiating a cleaning routine. For instance, in several embodiments, the control module 230 may be configured to compare a detected percentage of pixels within the data indicating debris 64 (FIG. 1) on a component of the harvester 10 to a defined threshold. If the detected percentage of pixels within the data indicating debris 64 (FIG. 1) on the panel 144 exceeds the threshold, the control module 230 may initiate the cleaning routine.

Moreover, as shown in FIG. 11, the computing system 202 may also include a communications interface 232 to communicate with any of the various other system components described herein. For instance, one or more communicative links or interfaces (e.g., one or more data buses and/or wireless connections) may be provided between the communications interface 232 and the input device(s) 204 to allow data transmitted from the input device(s) 204 to be received by the computing system 202. Additionally, as shown in FIG. 11, one or more communicative links or interfaces (e.g., one or more data buses and/or wireless connections) may be provided between the communications interface 232 and one or more electronically controlled components of the elevator assembly 62 to allow the computing system 202 to control the operation of such system components.

In operation, the sensor system 98 may capture data associated with the movement of the elevator 74 during a harvesting operation. For example, the movement sensor assembly 164 may detect movement of the one or more paddles 82 operably coupled with the elevator 74. In turn, each time a paddle 82 passes by the movement sensor assembly 164, or at any other frequency, indicating a subsequent region 84 transporting harvest material has passed the movement sensor assembly 164, the computing system 202 may activate the vision-based sensor assembly 110 to generate an image associated with an imaged region 84 that includes the harvested material on the elevator 74. The harvested material may include stalks 60S, which may be in the form of billets 60B, and debris 64 (FIG. 1), which is positioned on the elevator 74 within the imaged region 84. In turn, the data analysis module 228 may be configured to analyze the input data (e.g., a set of input data received at a given time or within a given time period or a subset of the data, which may be determined through a pre-processing method) to determine the operation-related condition. For example, the data analysis module 228 can utilize any suitable image processing algorithm(s) to determine an percentage of pixels within the data indicating debris 64 (FIG. 1) on a component (e.g., the panel 144 (FIG. 10)) within data provided by the sensor system 98. The control module 230 may be configured to compare a detected percentage of pixels within the data indicating debris 64 (FIG. 1) on a component of the harvester 10 to a defined threshold. If the detected percentage of pixels within the data indicating debris 64 (FIG. 1) on the panel 144 exceeds the threshold, the control module 230 may initiate the cleaning routine.

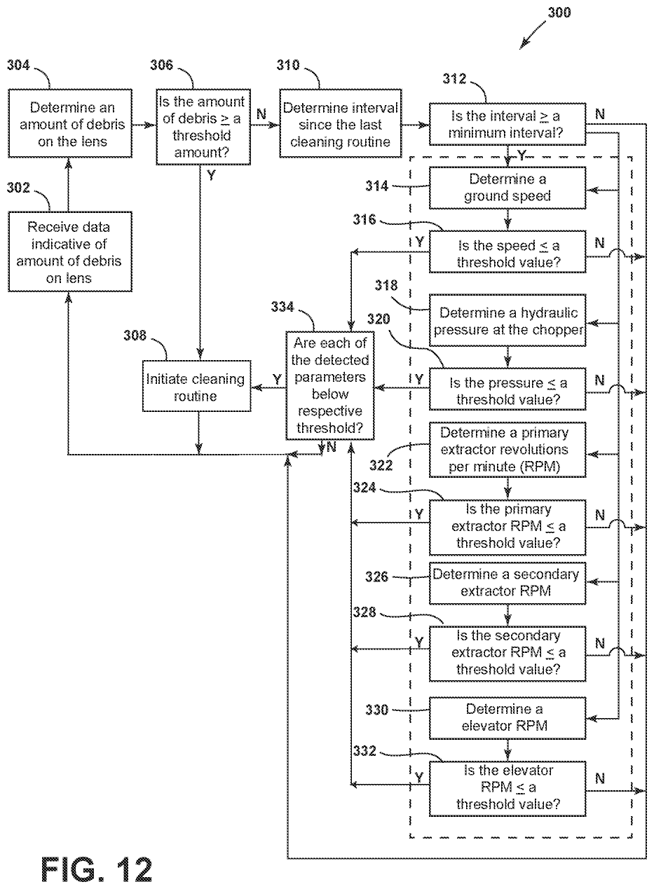

Referring now to FIG. 12, a flow diagram of a method 300 for operating an agricultural harvester is illustrated in accordance with aspects of the present subject matter. In general, the method 300 will be described herein with reference to the agricultural harvester 10 and related components described with reference to FIGS. 1-10, and the various components of the system 200 described with reference to FIG. 11. It will be appreciated, however, that the disclosed method 300 may be implemented with harvesters having any other suitable configurations and/or within systems having any other suitable system configuration. In addition, although FIG. 12 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 12, at (302), the method 300 can include receiving data from the input device(s) that is associated with one or more “operation-related” conditions. In various examples, the input device(s) may include the sensor system 98 coupled with the elevator assembly and/or one or more other sensor systems 98 configured to monitor one or more parameters and/or conditions associated with the harvester 10 and/or the operation being performed therewith.

At (304), the method 300 may include determining an amount of debris adhered to the panel, or other sensor system components through analysis data provided by the sensor system. For instance, as provided herein, any suitable image processing algorithm(s) may be utilized to determine the amount of debris adhered to the panel, or other sensor system components.

At (306), the method 300 can include determining whether the detected percentage of pixels within the image data indicating debris on the panel is greater than a threshold amount. In some embodiments, the method can compare subsequent images from the vision-based sensor assembly to determine whether each pixel within the image is sufficiently similar to a previous image within various regions of the image thereby indicating debris) or another material may be adhered to the panel (or any other component). Additionally or alternatively, the method may compare a sharpness of successive images in the first set of data to determine an amount of debris on a component of the harvester.

If the detected percentage of pixels within the image data indicating debris on the panel does exceed the threshold amount, at (308), the method 300 can include initiating a cleaning routine. The cleaning routine may include providing information to a user interface in the form of a suggestion to clean the panel. Additionally or alternatively, the cleaning routine can include activating a pump to direct fluid from a reservoir through a nozzle and towards the panel of the vision-based sensor. Additionally or alternatively, the cleaning routine can include activating an air pump to direct air through an air nozzle and toward the panel.

If the detected percentage of pixels within the image data indicating debris on the panel is equal to or less than the threshold amount, at (310), the method 300 can include determining the detected interval since the previous cleaning routine. At (312), the method 300 can include determining if the interval is greater than a minimum defined interval. If the detected interval is less than a defined interval, the method 300 can return to step (302). If the detected interval is greater than or equal to the defined interval, the method 300 can include measuring a parameter of the harvester (some of which are provided in the dashed box of FIG. 12), the parameter including at least one of a ground speed, a chopper hydraulic pressure, a primary extractor revolutions per minute (RPM), a secondary extractor RPM, an elevator RPM, any other component of the harvester, and/or a combination thereof. In such instances, the detection of the parameter during harvesting (e.g., a ground speed and a pressure above threshold), leaves, or other objects can fly around and get stuck between the wiper and the panel. In some cases, when the cleaning routine is to be triggered based on the interval exceeding a minimum defined interval (e.g., indicating that no urgent cleaning may be needed), the system may wait until a later in time opportunity where the chopper pressure and ground speed are low enough to indicate that the harvester is not performing a harvesting operation.

As illustrated, at (314), the method 300 can include determining, with the computing system, a detected ground speed of the harvester. In turn, at (316), the method 300 can include comparing the detected ground speed to a defined ground speed. If the detected ground speed is greater than the defined ground speed, the method 300 can return to (302). If the detected ground speed is less than or equal to the threshold defined ground speed, the method 300, can proceed to (332).

At (318), the method 300 can include determining a detected hydraulic pressure at the chopper assembly. At (320), the method 300 can include comparing the detected hydraulic pressure to a threshold pressure. If the detected hydraulic pressure is less than or equal to the threshold pressure, the method 300 can proceed to (332). If the detected hydraulic pressure is greater than the threshold pressure, the method 300 can proceed to (302).

At (322), the method 300 can include determining a detected primary extractor RPM. At (324), the method 300 can include comparing the detected primary extractor RPM to a threshold RPM. If the detected primary extractor RPM is less than or equal to the threshold RPM, the method 300 can proceed to (332). If the detected primary extractor RPM is greater than the threshold pressure, the method 300 can proceed to (302).

At (326), the method 300 can include determining a detected secondary extractor RPM. At (328), the method 300 can include comparing the detected secondary extractor RPM to a threshold RPM. If the detected secondary extractor RPM is less than or equal to the threshold RPM, the method 300 can proceed to (332). If the detected secondary extractor RPM is greater than the threshold pressure, the method 300 can proceed to (302).

At (330), the method 300 can include determining a detected elevator RPM. At (332), the method 300 can include comparing the detected elevator RPM to a threshold RPM. If the detected elevator RPM is less than or equal to the threshold RPM, the method 300 can proceed to (332). If the detected elevator RPM is greater than the threshold pressure, the method 300 can proceed to (302).

At (334), the method 300 can include determining whether each of the detected parameters is below their respective thresholds. If each of the detected parameters is below their respective thresholds, thereby potentially indicating that the harvester is not performing a harvesting operation, the method 300 can proceed to (308). If a defined number of the detected parameters are not below their respective thresholds (e.g., one or more), the method 300 can continue to (302).

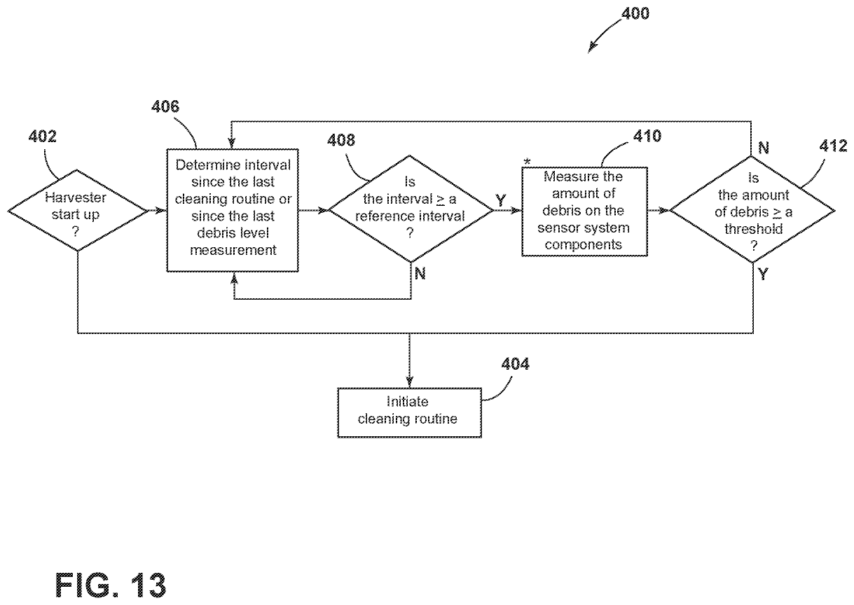

Referring now to FIG. 13, a flow diagram of a method 400 for operating an agricultural harvester is illustrated in accordance with aspects of the present subject matter. In general, the method 400 will be described herein with reference to the agricultural harvester 10 and related components described with reference to FIGS. 1-10, and the various components of the system 200 described with reference to FIG. 11. It will be appreciated, however, that the disclosed method 400 may be implemented with harvesters having any other suitable configurations and/or within systems having any other suitable system configuration. In addition, although FIG. 13 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As illustrated in FIG. 13, the method 400, at (402), can include determining whether the harvester is proceeding with a startup routine. If the harvester is performing a startup routine, the method 400, at (404), can include initiating a cleaning routine. The cleaning routine may include providing information to a user interface in the form of a suggestion to clean the panel. Additionally or alternatively, the cleaning routine can include activating a pump to direct fluid from a reservoir through a nozzle and towards the panel of the vision-based sensor. Additionally or alternatively, the cleaning routine can include activating an air pump to direct air through an air nozzle and toward the panel.

If the harvester is not performing a startup routine, the method 400, at (406), can include determining the interval since the previous cleaning routine or since the last debris level measurement. In turn, at (408), the method 400 can include determining if the interval greater than or equal to a reference interval. If the interval is not greater than or equal to a reference interval, the method 400 can return to (406).

If the interval is greater than or equal to a reference interval, at (410), the method 400 can include measuring an percentage of pixels within the image data indicating debris on the panel on one or more sensor system components (e.g., the panel of the vision-based sensor). For example, any suitable image processing algorithm(s) may be utilized to determine the amount of on a component of the sensor system 98 (e.g., the panel). In some embodiments, a texture-based algorithm may be utilized that relies on the orientations of image gradients to differentiate a billet or other debris that is transferred along the elevator from a debris 64 or other materials that may be adhered to the panel, or other sensor system components. In other embodiments, a color-based algorithm may be utilized that relies on color differences to differentiate between a billet or other debris that is transferred along the elevator from a debris or other materials that may be adhered to the panel, or other sensor system components. In further embodiments, the algorithm may identify the differences in the reflectivity or spectral absorption between a billet or other debris that is transferred along the elevator from a debris or other materials that may be adhered to the panel, or other sensor system component. Additionally or alternatively, the algorithm may utilize a fast Fourier transform (FFT) to determine an percentage of pixels within the image data indicating debris on the panel or other materials that may be adhered to the panel, or other sensor system components. It will be appreciated, however, that any suitable image processing algorithm(s) may be utilized to determine the operation-related condition.

At (412), the method 400 can include determining whether the detected percentage of pixels within the image data indicating debris on the panel is greater than a threshold amount. If the detected percentage of pixels within the image data indicating debris on the panel is equal to or greater than the threshold amount, the method 300 can continue to (404) and initiate a cleaning routine. If the detected percentage of pixels within the image data indicating debris on the panel is less than the threshold amount, the method 300 can continue to (406).

In various examples, the methods 300 and 400 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update any performed processes. In some instances, the machine learning engine may allow for changes to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural harvester, the system comprising:
a support structure configured to be operably coupled with an elevator housing;
a carrier operably coupled with the support structure;
a vision-based sensor operably coupled with the carrier;
one or more light sources operably coupled with the carrier;
a panel positioned along a portion of the carrier; and
a cleaning system configured to remove debris from the panel positioned between at least one of the vision-based sensor and the one or more light sources.

2. The system of claim 1, wherein the cleaning system further comprises:
a nozzle configured to direct at least one or a fluid or pressurized air at the panel.

3. The system of claim 2, wherein the cleaning system further comprises:
a wiper assembly configured to contact the panel and remove debris therefrom.

4. The system of claim 3, wherein the nozzle is positioned on a wiper of the wiper assembly and is movable with the wiper.

5. The system of claim 2, wherein the cleaning system further comprises:
a reservoir configured to retain a liquid for use by the cleaning system, wherein the liquid is received from an HVAC system.

6. The system of claim 1, further comprising:
a computing system operably coupled with the vision-based sensor, the one or more light sources, and the cleaning system, the computing system being configured to:
determine a detected percentage of pixels within the first set of data indicating debris on the panel on the panel; and
initiate a cleaning routine to remove at least a portion of the debris from the panel.

7. The system of claim 6, wherein the cleaning routine removes at least a portion of the debris that is within a light source focal region of the panel or a vision-based sensor focal region of the panel.

8. The system of claim 1, further comprising:
a cover positioned on an opposing side of the support structure from the carrier.

9. The system of claim 5, further comprising:
a pump fluidly coupled between the reservoir and the nozzle; and
a valve positioned between the nozzle and the pump.

10. A computer-implemented method for agricultural harvesting, the computer-implemented method comprising:
receiving, from a sensor system, data indicative of an percentage of pixels within the data indicating debris on the panel on a panel of a sensor;
determining, with a computing system, a detected percentage of pixels within the data indicating debris on the panel on the panel;
comparing, with the computing system, the detected percentage of pixels within the data indicating debris on the panel to a threshold amount; and
initiating, with a cleaning system, a cleaning routine when the detected percentage of pixels within the data indicating debris on the panel is greater than or equal to a threshold amount.

11. The computer-implemented method of claim 10, wherein determining, with the computing system, a detected percentage of pixels within the data indicating debris on the panel on the panel comprises utilizing an image processing algorithm to determine the detected percentage of pixels within the data indicating debris on the panel adhered to the panel.

12. The computer-implemented method of claim 10, wherein the cleaning routine comprises activating, with the computing system, a pump to direct fluid from a reservoir through a nozzle and towards the panel of the sensor.

13. The computer-implemented method of claim 10, wherein the cleaning routine comprises activating, with the computing system, an air pump to direct air through an air nozzle and towards the panel.

14. The computer-implemented method of claim 10, further comprising:
determining, with the computing system, a detected interval since a previous cleaning routine.

15. The computer-implemented method of claim 10, further comprising:
measuring, with the computing system, a parameter of the harvester, the parameter including at least one of a ground speed, a chopper pressure, a primary extractor revolutions per minute (RPM), a secondary extractor RPM, an elevator RPM, or a combination thereof.

16. A system for an agricultural harvester, the system comprising:
a support structure configured to be operably coupled with an elevator housing;
a carrier operably coupled with the support structure;
a vision-based sensor operably coupled with the carrier;
one or more light sources operably coupled with the carrier;
a panel positioned along a portion of the carrier;
a cleaning system configured to remove debris from the panel positioned between at least one of the vision-based sensor and the one or more light sources; and
a computing system including one or more processors and one or more non-transitory computer-readable media that collectively store instructions that, when executed by the one or more processors, configure the computing system to perform operations, the operations comprising:
determining a detected percentage of pixels within the data indicating debris on the panel on the panel; and
initiating a cleaning routine to remove at least a portion of the debris from the panel.

17. The system of claim 16, wherein the cleaning system further comprises:
a nozzle configured to direct at least one or a fluid or pressurized air at the panel.

18. The system of claim 17, wherein the cleaning system further comprises:
a wiper assembly configured to contact the panel and remove debris therefrom.

19. The system of claim 18, wherein the nozzle is positioned on a wiper of the wiper assembly and is movable with the wiper.

20. The system of claim 17, wherein the cleaning system further comprises:
a reservoir configured to retain a liquid for use by the cleaning system, wherein the liquid is received from an HVAC system.
